(19) United States
(12) Patent Application Publication
(10) Pub. No.: US 2011/0041189 A1
(43) Pub. Date: Feb. 17, 2011

(54) SYSTEM AND METHOD TO PROVIDE A USER-GENERATED IMAGE GALLERY

(76) Inventor: Scott Robert Shipman, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/541,079

(22) Filed: Aug. 13, 2009

(51) Int. Cl. G06F 15/16; G06F 21/00; G06F 17/30

(52) U.S. Cl. 726/30; 709/217; 707/E17.014

(57) ABSTRACT

In various exemplary embodiments, a system and an associated method to provide a user-generated image gallery is provided. Initially, a product category of a product infrastructure associated with an item represented by an image is determined. A new product category may be generated based on a determination that the product category is not adequately associated with the item represented by the image. Subsequently, an upload of the image is received from the user. The uploaded image may then be stored whereby the uploaded image is associated with the user and the product category or the new product category is based on the determination.

### TECHNICAL FIELD

The present application relates generally to the field of computer technology and, in a specific exemplary embodiment, to a system and method for providing a user-generated image gallery in a networked environment.

### BACKGROUND

In a multi-seller network-based marketplace, sellers list products offered for sale or auction. Often these listings include one or more images of the product. While some sellers have the capability to take their own images, other sellers do not have the time, equipment, or talent to take good images of their products. In some of these latter cases, the sellers may be tempted to use misappropriated or potentially copyrighted images.

### BRIEF DESCRIPTION OF DRAWINGS

Various ones of the appended drawings merely illustrate exemplary embodiments of the present invention and cannot be considered as limiting its scope.

FIG. 1 is a block diagram illustrating an exemplary embodiment of a high-level, client-server-based network architecture of a system used to provide targeted merchandising.

FIG. 2 is a block diagram illustrating an exemplary embodiment of a marketplace system of the network architecture of FIG. 1.

FIG. 3 is a block diagram illustrating an exemplary imaging engine.

FIG. 4 is a flowchart illustrating an exemplary method for generating a user-generated image gallery.

FIG. 5 is a flowchart illustrating an exemplary method for maintaining the user-generated image gallery.

FIG. 6 is a flowchart illustrating an exemplary method for providing images from the user-generated image gallery for use.

FIG. 7 is a simplified block diagram of a machine in an exemplary form of a computing system within which a set of instructions for causing the machine to perform any one or more of the methodologies discussed herein may be executed.

### DETAILED DESCRIPTION

The description that follows includes illustrative systems, methods, techniques, instruction sequences, and computing machine program products that embody the present inventive subject matter. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or an exclusive sense. Similarly, the term “exemplary” is construed merely to mean an example of something or an exemplar and not necessarily a preferred or ideal means of accomplishing a goal. Additionally, although various exemplary embodiments discussed below focus on a network-based marketplace environment, the embodiments are given merely for clarity in disclosure. Thus, any type of electronic commerce or electronic business system and method, including various system architectures, may employ various embodiments of the user-generated photo galley systems and methods described herein, and are considered as being within a scope of exemplary embodiments. Each of a variety of exemplary embodiments is discussed in detail below.

Exemplary embodiments provide a system and method to provide a user-generated image gallery. Initially, a product category of a product infrastructure associated with an item represented by an image is determined. A new product category may be generated based on a determination that the product category is not adequately associated with the item represented by the image. Subsequently, an upload of the image is received from the user. The uploaded image may then be stored in the user-generated image gallery whereby the uploaded image is associated with the user and the product category or new product category based on the determination. The image may then be used by subsequent users.

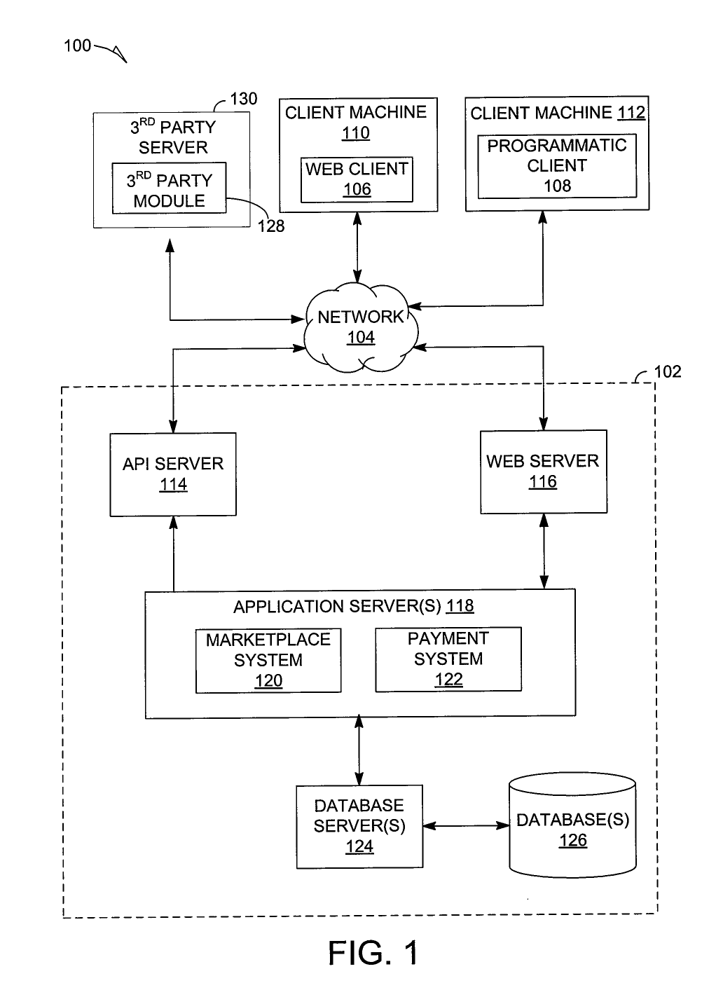

With reference to FIG. 1, an exemplary embodiment of a high-level client-server-based network architecture 100 to create user-generated photo categories is shown. A networked system 102, in an exemplary form of a network-server-side functionality, is coupled via a network 104 (e.g., the Internet or Wide Area Network (WAN)) to one or more clients. FIG. 1 illustrates, for example, a web client 106 operating via a browser (e.g., such as the Internet Explorer® browser developed by Microsoft® Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host a marketplace system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage databases 126.

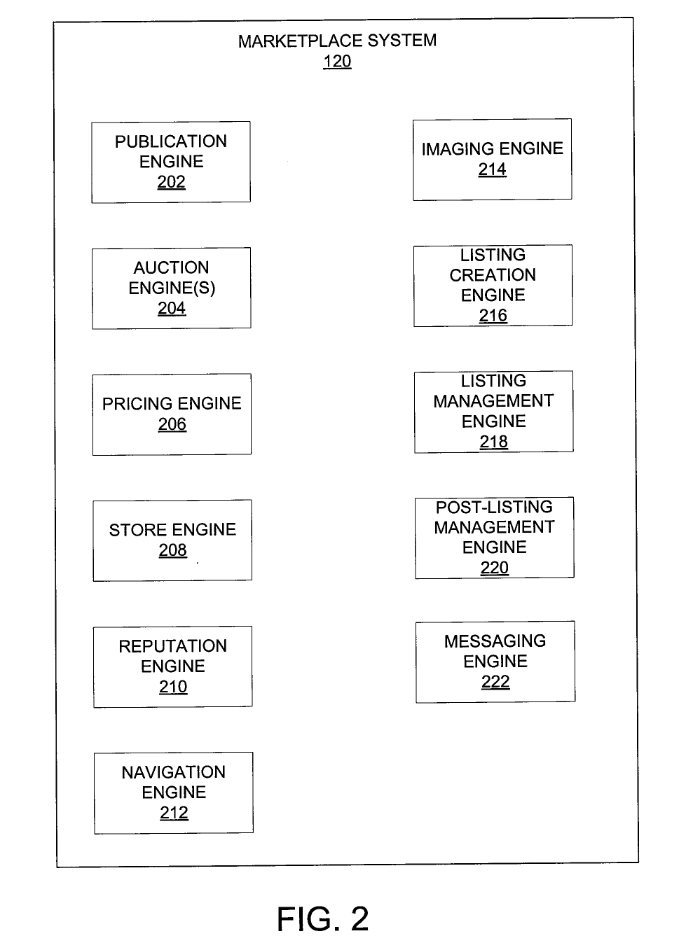

The marketplace system 120 provides a number of marketplace functions and services to users that access the networked system 102. The marketplace system 120 is discussed in more detail in connection with FIG. 2.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the marketplace system 120. The payment system 122 also facilitates payments from a payment mechanism (e.g., a bank account or credit card) for purchases of items via the network-based marketplace. While the marketplace system 120 and the payment system 122 are shown in FIG. 1 to both form part of the networked system 102, it will be appreciated that, in alternative embodiments, the payment system 122 may form part of a payment service that is separate and distinct from the networked system 102.

FIG. 1 also illustrates a third party module 128, executing on a third party server 130, as having programmatic access through the network 104 to the networked system 102 via the programmatic interface provided by the API server 114. For example, the third party module 128 may, utilizing information retrieved from the networked system 102, support one or more features or functions on a website (not shown) hosted by the third party. The third party website may, for example, provide one or more promotional, marketplace, or payment functions that are supported by the relevant applications of the networked system 102.

While the exemplary network architecture 100 of FIG. 1 employs a client-server architecture, a skilled artisan will recognize that the present disclosure is not limited to such an architecture. The exemplary network architecture 100 can equally well find application in, for example, a distributed or peer-to-peer architecture system. The marketplace system 120 and payment system 122 may also be implemented as standalone systems or standalone software programs operating under separate hardware platforms, which do not necessarily have networking capabilities.

Referring now to FIG. 2, an exemplary block diagram illustrating multiple components that, in one exemplary embodiment, are provided within the marketplace system 120 of the networked system 102 (see FIG. 1) is shown. The marketplace system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more information storage databases 126 via the one or more database servers 124, both shown in FIG. 1.

The marketplace system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace system 120 may comprise at least one publication engine 202 and one or more auction engines 204 that support auction-format listing and price setting mechanisms (e.g., English, Dutch, Chinese, Double, Reverse auctions, etc.). Various ones of the auction engines 204 also provide a number of features in support of these auction-format listings, such as a reserve price feature whereby a seller may specify a reserve price in connection with a listing, and a proxy-bidding feature whereby a bidder may invoke automated proxy bidding.

A pricing engine 206 supports various price listing formats. One such format is a fixed-price listing format (e.g., the traditional classified advertisement-type listing or a catalogue listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102 of FIG. 1, to establish, build, and maintain reputations. These reputations may be made available and published to potential trading partners. Because the marketplace system 120 supports person-to-person trading between unknown entities, users may otherwise have no history or other reference information whereby the trustworthiness and credibility of potential trading partners may be assessed. The reputation engine 210 allows a user, for example through feedback provided by one or more other transaction partners, to establish a reputation within the network-based marketplace over time. Other potential trading partners may then reference the reputation for purposes of assessing credibility and trustworthiness.

Navigation of the network-based marketplace may be facilitated by a navigation engine 212. For example, a search module (not shown) of the navigation engine 212 enables keyword searches of listings published via the marketplace system 120. In a further example, a browse module (not shown) of the navigation engine 212 allows users to browse various category, catalogue, or inventory data structures according to which listings may be classified within the marketplace system 120. Various other navigation applications within the navigation engine 212 may be provided to supplement the searching and browsing applications.

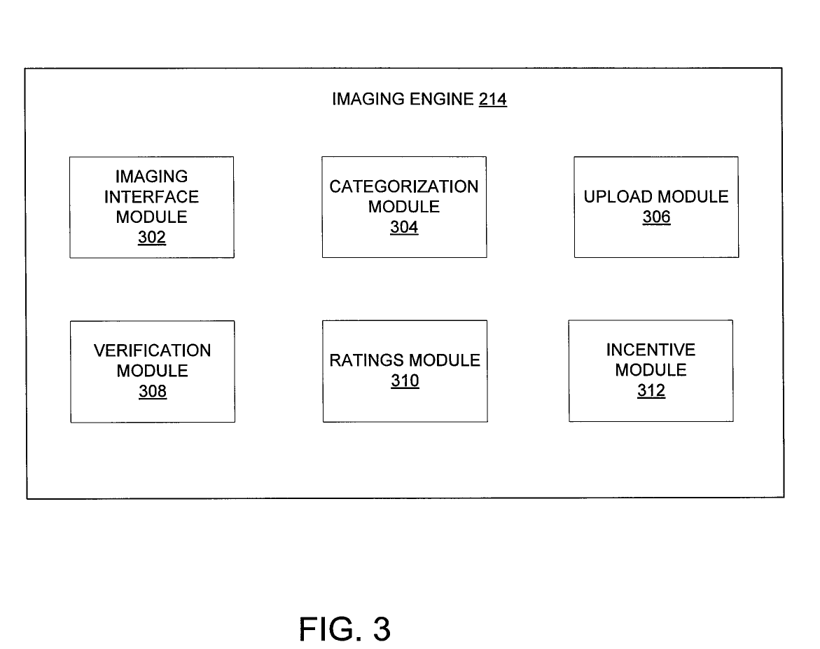

In order to make listings available via the networked system 102 as visually informing and attractive as possible, the marketplace system 120 may include an imaging engine 214 that enables users to upload images for inclusion within listings. The imaging engine 214 also operates to incorporate images within viewed listings. The imaging engine 214 may also support one or more promotional features, such as image galleries that are presented to potential buyers. For example, sellers may pay an additional fee to use an image from the image gallery to promote their products. The imaging engine 214 will be discussed in more detail in connection with FIG. 3 below.

A listing creation engine 216 allows sellers to conveniently author listings pertaining to goods or services that sellers wish to transact via the marketplace system 120, and a listing management engine 218 allows sellers to manage such listings. Specifically, where a particular seller has authored or published a large number of listings, the management of such listings may present a challenge. The listing management engine 218 provides a number of features (e.g., auto-relisting, inventory level monitors, etc.) to assist the seller in managing such listings.

A post-listing management engine 220 also assists sellers with a number of activities that typically occur post-listing. For example, upon completion of an auction facilitated by the one or more auction engines 204, a seller may wish to leave feedback regarding a particular buyer. To this end, the post-listing management engine 220 provides an interface to the reputation engine 210 allowing the seller conveniently to provide feedback regarding multiple buyers to the reputation engine 210.

A messaging engine 222 is responsible for the generation and delivery of messages to users of the networked system 102 of FIG. 1. Such messages include, for example, advising users regarding the status of listings and best offers (e.g., providing an acceptance notice to a buyer who made a best offer to a seller). The messaging engine 222 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, or WiMAX).

Although the various components of the marketplace system 120 have been defined in terms of a variety of individual modules and engines, a skilled artisan will recognize that many of the items can be combined or organized in other ways. Furthermore, not all components of the marketplace system 120 have been included in FIG. 2. In general, components, protocols, structures, and techniques not directly related to functions of exemplary embodiments (e.g., a dispute resolution engine, a loyalty promotion engine, a personalization engines, etc.) have not been shown or discussed in detail. The description given herein simply provides a variety of exemplary embodiments to aid the reader in an understanding of the systems and methods used herein.

Application of Embodiments of the Image Gallery Platform into the Exemplary Network Architecture

Referring now to FIG. 3, an exemplary diagram of the imaging engine 214 is shown. The imaging engine 214 provides mechanisms to maintain an image gallery comprising user-generated images. The images contained within the image gallery may be used by other individuals. In one embodiment, the image gallery is stored in at least one of the one or more information storage databases 126. One example of a use of stock images from the image gallery is for inclusion in product listings in a network-based marketplace system. This use of stock images from the image gallery helps alleviate previous problems such as lack of quality images and use of potentially copyrighted images. It should be noted that the image galley may also comprise images from sources other than users (e.g., purchased catalog of images).

In exemplary embodiments, the imaging engine 214 comprises an imaging interface module 302, a categorization module 304, an upload module 306, a verification module 308, a ratings module 310, and an incentive module 312. Alternative embodiments may comprise further components or modules not directly related to exemplary embodiments of the user-generated imaging system, and thus are not shown or discussed. Each of these modules can be implemented in hardware, software, firmware, or any combination thereof.

The imaging interface module 302 provides a user interface for user interaction with the various modules of the imaging engine 214 and the image gallery. In exemplary embodiments, the user interface allows the user to upload images, search for images from the image gallery, and incorporate images into a product listing associated with an item or product that the user is offering to sell.

The categorization module 304 manages product categories of a product infrastructure that is used to categorize images in the image gallery. In exemplary embodiments, the product categories used to categorize images will correspond to, or be the same as, product categories that are used to categorize items for sale or auction in the network-based marketplace. In an example using a Sony® Playstation® 2, the product infrastructure may provide a product hierarchy as follows: (1) electronics→entertainment→gaming→game→consoles→Sony® Playstations. By navigating (or performing a keyword search) the product infrastructure, a user may determine a lowest level product category to which the user may upload images or from which the user may elect images to use. In the present example, the lowest level product category is Sony® Playstations.

The categorization module 304 also allows a user to create a new product category if needed. Continuing with the Sony® Playstation® example, a user may desire to create a product category a level lower than Sony® Playstations. In this case, the user can create a product category for Sony® Playstation 2. In one embodiment, the creation of the new product category may require approval of an administrator associated with the network-based marketplace system. As such, the categorization module 304 allows a user of a community to help build the product infrastructure. It should be noted that the new product category does not necessarily need to be a sub-category of the lowest level product category. For example, the user may determine that a product category on a same level as the determined lowest product category may be desired (e.g., create a product category from a second lowest product category level).

It should be noted that in alternative embodiments, the categorization module 304 may be located elsewhere in the marketplace system 120. For example, the categorization module may comprise its own engine or be a part of the auction engine(s) 204.

The upload module 306 allows a user to upload his or her images. In some cases, the user uploads the user's own images to use in creating the user's own product listings. In other cases, the user uploads images for use in the image gallery. Once uploaded, the images may be stored to a database (e.g., to at least one of the one or more information storage databases 126).

The verification module 308 verifies that the uploaded image is likely, for example, a non-copyrighted image and is thus, non-infringing. In exemplary embodiments, an assumption is made that images from a registered user are not infringing potentially copyrighted images. Accordingly, the verification module 308 may determine if the uploaded image is being received from a domain and whether the uploaded image is, for example, a .gif file from a registered user's digital device (e.g., a computer or mobile phone) to verify the authenticity of the image. Additionally, the verification module 308 manages reports (e.g., via community feedback) that an image may be an infringing image.

The ratings module 310 manages ratings associated with images in the image gallery. The ratings may comprise use ratings (e.g., a number of times an image is used) whereby the images may be ranked or otherwise distinguished based on usage. The ratings may also comprise community feedback. Community feedback may include, for example, comments on the image and a scale rating (e.g., on a scale of one to five). Virtually any form of rating or ranking of an image may be used and managed by the ratings module 310. In one embodiment, poorly rated images may be removed from the system.

The incentive module 312 manages incentives associated with the images in the image gallery. In various embodiments, users are incentivized to provide images to the image gallery. For example, micropayments may be provided to the user for every use of his image (e.g., $0.05) or when a threshold is reached (e.g., a $10 coupon is issued when an image is used more than 20 times). Incentives may also be provided for quality of the image. For example, ratings may be assigned to each image. The ratings may represent a number of uses (e.g., the more the image is used, the higher the rating). Alternatively, the ratings may represent community feedback on the images (e.g., users in the community rate on a scale of one to five). Incentives may comprise non-monetary incentives. For example, awards may be given out to the best-rated image in each product category. In some embodiments, promotions may be applied to product categories where images may be lacking. If a user submits images in response to these promotions, the user may also receive an incentive.

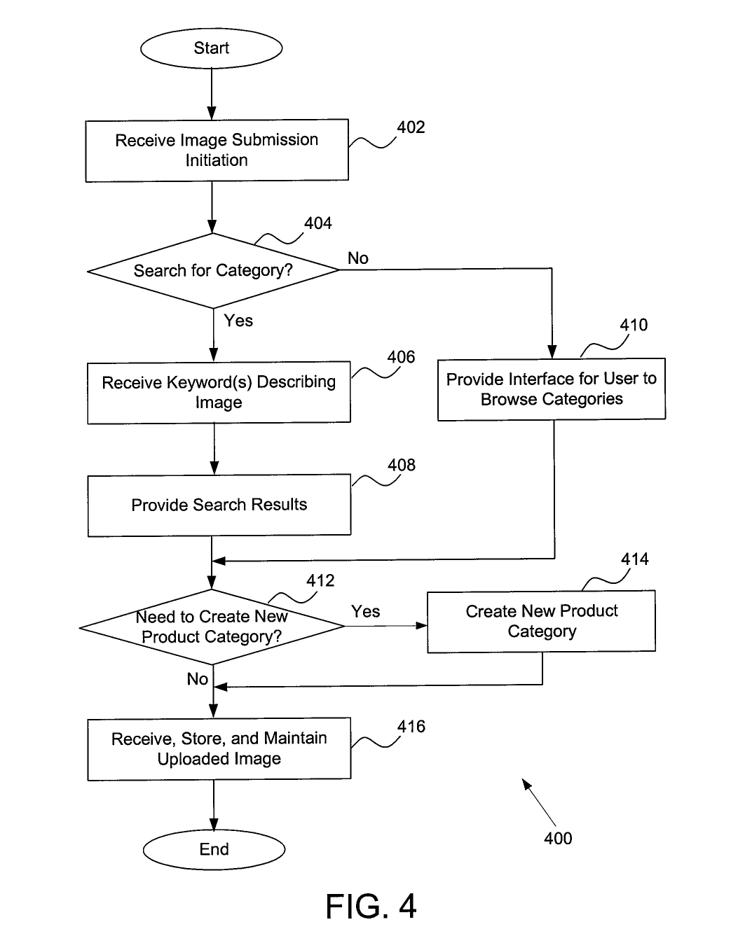

FIG. 4 is a flowchart illustrating an exemplary method 400 for generating and populating a user-generated image gallery. At operation 402, an image submission initiation is received. In exemplary embodiments, a user accesses a graphical interface wherein the user may select to upload an image. By selecting an upload option, the image submission process is initiated. In one embodiment, the image submission process walks the user through a series of graphical interfaces that allows the user to select a category in which to upload an image and to upload and store the image accordingly.

A determination is made at operation 404 as to whether the user performs a keyword search to determine a lowest product category in a product infrastructure to which to upload the image. If the user performs a search, one or more keywords describing an item being represented by the image is received at operation 406. Subsequently, a search result is returned in operation 408. In exemplary embodiments, the search result comprises one or more product categories to which the user may navigate. In one embodiment, the search is performed by the categorization module 304 of FIG. 3.

Instead of performing a keyword search, a user may browse and select through a hierarchy of the product infrastructure. Accordingly, a browser interface is provided to the user at operation 410. The user may then navigate through the product infrastructure to arrive at a lowest product category of the product infrastructure that is directed to the item represented by the image the user desires to sell or auction.

Once the lowest category of the product infrastructure is found, a determination is made at operation 412 as to whether a new product category should be created. In some embodiments, the user decides that the lowest category in the product infrastructure is still at too high a level to adequately organize the images within. For example, a search or navigation through the product infrastructure may take a user through the following hierarchy: electronics→entertainment→gaming→game consoles→Sony® Playstations. Thus, the lowest product category is “Sony® Playstations.” However, the user may desire to establish a sub-category directed to Sony® Playstation® 2. In this case, a new product category is created in operation 414. According to one embodiment, the categorization module 304 creates the new product category. In one embodiment, the new product category may be subject to approval by an administrator associated with the network-based marketplace system.

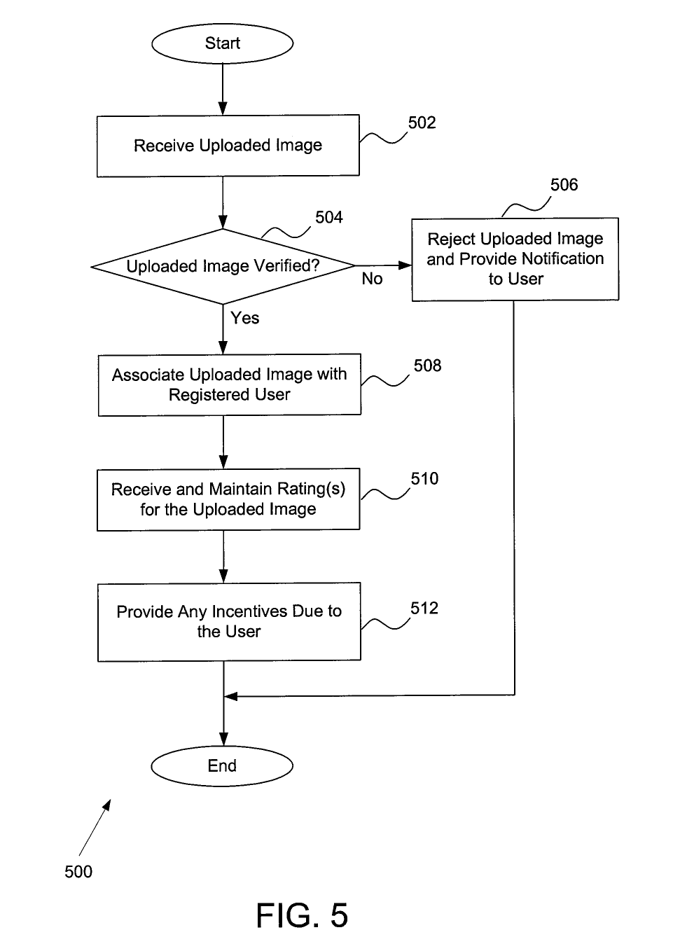

Subsequently, the uploaded image is received and stored in operation 416. Details associated with performing operation 416 are described further in connection with FIG. 5 below.

With reference to FIG. 3 and FIG. 5 concurrently, an exemplary method 500 for maintaining the image gallery is illustrated. At operation 502, the uploaded image is received by the networked system 102. In one embodiment, the upload module 306 receives the uploaded image.

The uploaded image is then verified in operation 504. In one embodiment, the verification module 308 verifies whether the uploaded image is authentic (e.g., that the image does not infringe a potentially copyrighted image) by determining if the upload image is coming from a registered user. This determination may include determining if the uploaded image is received from a domain and whether the uploaded image is, for example, a .gif file from the registered user's digital device (e.g., a computer or mobile phone). If the uploaded image does not satisfy criteria of the verification module 308, then the uploaded image is rejected and a notification to that effect is provided to the user at operation 506. The verification module 308 may manage the notification process.

If the uploaded image is verified, then the uploaded image is associated with a registered user in operation 508, and stored for use in an image gallery. In exemplary embodiments, the user logs into (or otherwise provides an identification to) the networked system 102. As such, the upload module 306 knows the identity of the registered user and can associate the uploaded image with the registered user. By associating the uploaded image, proper credit or incentives may be given to the registered user for use of the user's uploaded image.

Over time, ratings may be received for the uploaded image at operation 510. In one embodiment, the ratings module 310 manages the ratings associated with the uploaded image. The ratings may comprise user ratings (e.g., a number of times an image is used) and community feedback (e.g., comments provided about the image or a scale rating). Virtually any form of rating or ranking the uploaded image may be used.

At operation 512, any incentives due to the user are determined and provided. In exemplary embodiments, the incentive module 312 manages incentives associated with the uploaded image in the image gallery. For example, micropayments may be provided for every use of an uploaded image (e.g., $0.05) or when a threshold is reached (e.g., providing a $10 coupon when an image is used more than 20 times). Incentives may also be provided for quality of the image (e.g., based on ratings). If a user submits images in response to these promotions, the user may also receive an incentive.

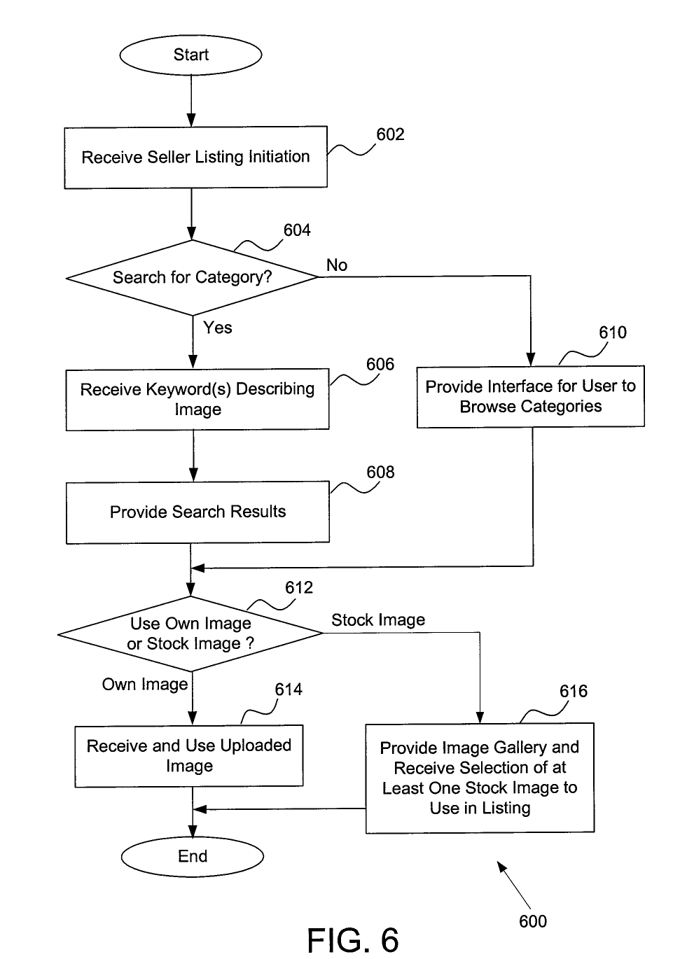

FIG. 6 is a flowchart illustrating an exemplary method 600 for providing images from the image gallery for use in a network-based marketplace. At operation 602, a listing initiation is received from a user (e.g., a seller or merchant). In one embodiment the user accesses an interface that starts a product listing process.

At operation 604, a determination is made as to whether the user will perform a keyword search for a product category in which an item the user is attempting to sell is associated. If the user does perform a keyword search for the product category, then keywords are received at operation 606, and subsequent results are provided in operation 608. The results may comprise one or more product categories that match the keywords from which the seller may select a lowest product category. Alternatively, the user may browse through the product infrastructure for the lowest product category via a user interface at operation 610.

Once the lowest product category is determined, a further determination is made at operation 612 as to whether the user will use his or her own image or use an uploaded image (also referred to as “stock image”) from the image gallery for populating the product listing. If the user decides to use his or her own image, then the image is uploaded and used to populate the product listing at operation 614. The user may also allow the uploaded image to be stored for use in the image gallery.

If the user decides to use a stock image, then stock images in the selected product category from the image galley are presented to the user at operation 616. The user may review the stock images and select one or more of the stock images for use in the product listing. In one embodiment, the user provides a fee for using the stock image.

It is appreciated that the methods of FIG. 4-FIG. 6 are exemplary. Alternative embodiments may comprise more, less, or functionally equivalent steps. Additionally, the steps of the various methods may be practiced in a different order or be combined. For example, operation 404 may be combined with operation 406, and similarly, operation 604 may be combined with operation 606. Furthermore, while embodiments have been described with reference to using stock images in product listings, alternative embodiments may contemplate using stock images for other functions (e.g., to populate web pages or create photo albums).

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Medium

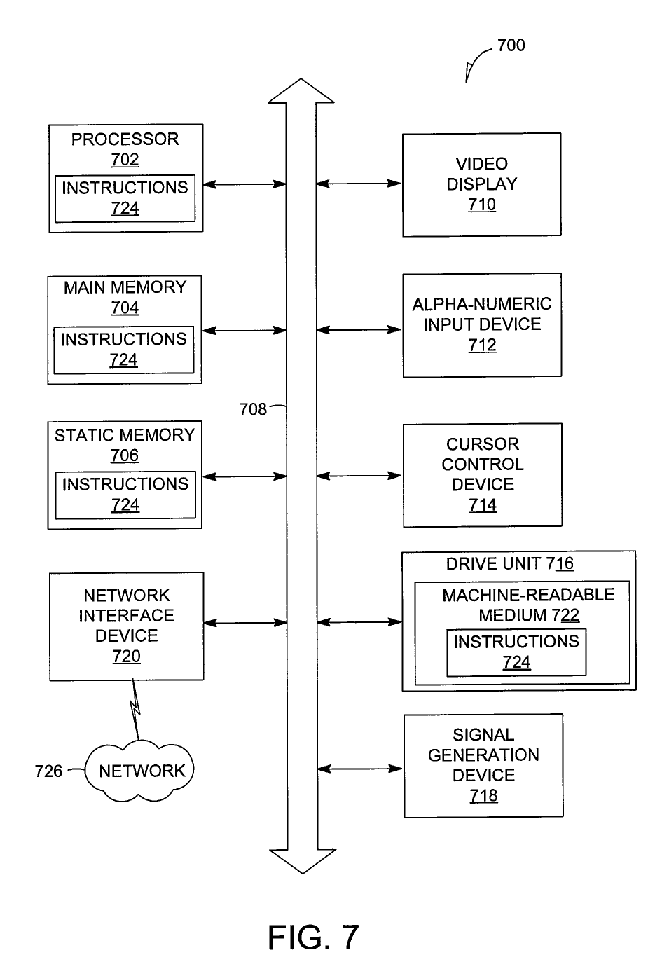

With reference to FIG. 7, an exemplary embodiment extends to a machine in the exemplary form of a computer system 700 within which instructions for causing the machine to perform any one or more of the methodologies discussed herein may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In exemplary embodiments, the computer system 700 also includes one or more of an alpha-numeric input device 712 (e.g., a keyboard), a user interface (UI) navigation device or cursor control device 714 (e.g., a mouse), a disk drive unit 716, a signal generation device 718 (e.g., a speaker), and a network interface device 720.

### Machine-Readable Medium

The disk drive unit 716 includes a machine-readable medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, the main memory 704 and the processor 702 also constituting machine-readable media.

While the machine-readable medium 722 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method to provide a user-generated photo gallery, the method comprising:
determining a product category associated with an item represented by an image;
generating a new product category based on a determination that the product category is not adequately associated with the item represented by the image;
receiving an upload of the image from a user;
storing the uploaded image; and
based on the determination that the product category is not adequately associated with the item, associating the uploaded image with the new product category otherwise associating the uploaded image with the product category.

2. The method of claim 1, further comprising verifying an authenticity of the uploaded image.

3. The method of claim 1, wherein determining the product category comprises performing a keyword search for the item.

4. The method of claim 1, further comprising providing an incentive to the user for providing the uploaded image.

5. The method of claim 1, further comprising rating the uploaded image based on a number of uses of the uploaded image.

6. The method of claim 1, further comprising rating the uploaded image based on community feedback.

7. The method of claim 1, further comprising providing the uploaded image as part of a gallery of stock images associated with the product category for use by one or more other users.

8. A system to provide a user-generated image gallery, the system comprising:
a categorization module to determine a product category associated with an item represented by an image and to generate a new product category based on a determination that the product category is not adequately associated with the item represented by the image; and
an upload module to receive an upload of the image from a user and to store the uploaded image; and based on the determination that the product category is not adequately associated with the item, to associate the uploaded image with the new product category, otherwise, to associate the uploaded image with the product category.

9. The system of claim 8, further comprising a verification module to verify an authenticity of the uploaded image.

10. The system of claim 8, further comprising a rating module to rate the uploaded image based on a number of uses of the uploaded image.

11. The system of claim 8, further comprising a rating module to rate the uploaded image based on community feedback.

12. The system of claim 8, further comprising an incentive module to provide an incentive to the user for providing the uploaded image.

13. A machine-readable storage medium in communication with at least one processor, the machine-readable storage medium storing instructions which, when executed by the at least one processor, provides a method for providing a user-generated image gallery, the method comprising:
determining a product category associated with an item represented by an image;
generating a new product category based on a determination that the product category is not adequately associated with the item represented by the image;
receiving an upload of the image from a user;
storing the uploaded image; and
based on the determination that the product category is not adequately associated with the item, associating the uploaded image with the new product category otherwise associating the uploaded image with the product category.

14. The machine-readable storage medium of claim 13, wherein the method further comprises verifying an authenticity of the uploaded image.

15. The machine-readable storage medium of claim 13, wherein the method further comprises providing an incentive to the user for providing the uploaded image.

16. The machine-readable storage medium of claim 13, wherein the method further comprises rating the uploaded image based on a number of uses of the uploaded image.

17. The machine-readable storage medium of claim 13, wherein the method further comprises rating the uploaded image based on community feedback.

18. The machine-readable storage medium of claim 13, wherein the method further comprises providing the uploaded image as part of a gallery of stock photos associated with the product category for use by one or more other users.

19. A system to provide a user-generated image gallery, the system comprising:
means for determining a product infrastructure associated with a product represented by an image; and
means for generating a new product category based on a determination that an existing product category is not adequately associated with an item represented by the image.

20. The system of claim 19 further comprising:
means for receiving an upload of the image from a user; and
means for storing the uploaded image; and
means for associating the uploaded image with the new product category based on the determination that the existing product category is not adequately associated with the item; and
means for associating the uploaded image with the existing product category based on the determination that the existing product category is adequately associated with the item.
